(19) United States
(12) Patent Application Publication
(10) Pub. No.: US 2006/0247905 A1
(43) Pub. Date: Nov. 2, 2006

(54) System, method and apparatus for placing and routing

(76) Inventors: Vikas Agrawal, Bangalore (IN); Pratheet Nair, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/150,029

(22) Filed: Jun. 10, 2005

Related U.S. Application Data
(60) Provisional application No. 60/676,397, filed on Apr. 29, 2005.

(51) Int. Cl. G06F 17/50

(52) U.S. Cl. 703/14

(57) ABSTRACT

Described herein are system(s), method(s), and/or apparatus for placing and routing. In one embodiment, there is presented a system for simulating a circuit. The system comprises a modeler and a place and route engine. The modeler models a first module and printed circuit connections connecting the first module to a second module, as a combined model, and models the second module. The place and route engine simulates a model comprising the combined model and the model of the second module.

### RELATED APPLICATIONS

This application claims priority to “SYSTEM, METHOD, AND APPARATUS FOR PLACING AND ROUTING”, Provisional Application for U.S. patent application Ser. No. 60/676,397, filed Apr. 29, 2005, by Nair, et. al.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

In a memory system, a Dual Data Rate (DDR) controller interacts with an SD-RAM memory. The SD-RAM is usually a separate integrated circuit from the SD-RAM. The SD-RAM and DDR controller can be mounted on a printed circuit board to allow interaction therebetween.

There are a number of constraints that are imposed on the DDR controller and SD-RAM. These constraints are often related to timing issues. For example, a data query signal (DQS) is used for interaction between the SD-RAM and the DDR controller. There are several timing constraints on the DQS.

A function of a design tool, known as a place and route (PNR), is used to simulate integrated circuits and board level circuits. However, many constraints between the DDR controller and the SD-RAM cannot be translated into the PNR environment.

Further limitations and disadvantages of conventional and traditional systems will become apparent to one of skill in the art through comparison of such systems with the invention as set forth in the remainder of the present application with reference to the drawings.

### SUMMARY OF THE INVENTION

Aspects of the present invention may be found in system(s), method(s), and/or apparatus for simulating a circuit, substantially as shown in and/or described in connection with at least one of he figures, as set forth more completely in the claims.

These and other advantages and novel features of the present invention, as well as details of illustrated examples embodiments thereof, will be more fully understood from the following description and drawings.

### BRIEF DESCRIPTION OF THE DRAWINGS

FIG. 1 is a block diagram describing an exemplary circuit that can be modeled in accordance with an embodiment of the present invention;

FIG. 2 is a flow diagram for modeling a circuit in accordance with an embodiment of the present invention;.

FIG. 3 is a block diagram of a system for simulating and verifying a circuit in accordance with an embodiment of the present invention;

FIG. 4 is a block diagram of a memory system that can be modeled in accordance with an embodiment of the present invention;

FIG. 5 is a flow diagram for modeling a memory system in accordance with an embodiment of the present invention;

FIG. 6 is a block diagram of a system for simulating and verifying a circuit in accordance with an embodiment of the present invention; and

FIG. 7 is a block diagram of an information handling system configured in accordance with an embodiment of the present invention.

### DETAILED DESCRIPTION OF THE INVENTION

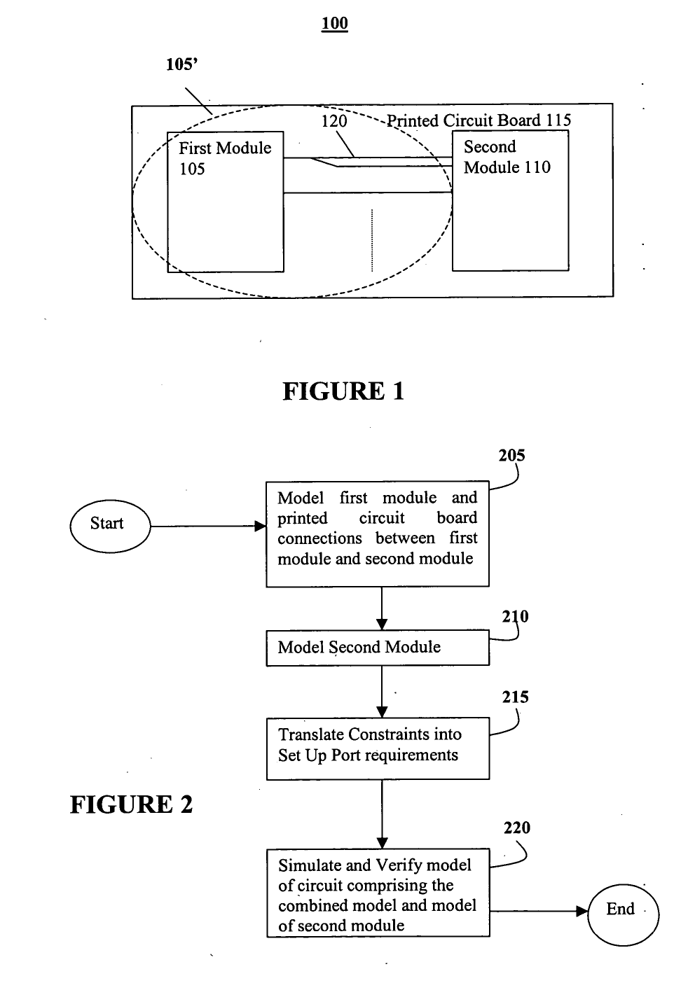

Referring now to FIG. 1, there is illustrated a block diagram describing an exemplary circuit 100 that can be modeled in accordance with an embodiment of the present invention. The circuit comprises a first module 105, a second module 110, and a printed circuit board 115 connecting the first module 105 to the second module 110.

The first module 105 and second module 110 can comprise a variety of items. For example, the first module 105 and second module 110 can comprise integrated circuits. Alternatively, the first module 105 and second module 110 themselves, comprise printed circuit boards. Thus the first and second modules 105, 110 will be understood to comprise circuits that, by themselves, are physically separate from one another.

Accordingly, the first module 105 and second module 110 are mounted to the printed circuit board 115. The printed circuit board 115 provides electrical connections 420 whereby the first module 105 and second module 110 can send signals to each other. The signals between the first module and the second module may have a number of constraints. These constraints can be related to, for example, timing issues.

Electronic circuits, such as circuit 100, the first module 105, the second module 110, and the printed circuit board 115, are characterized by large initial cost of fabricating a first copy, and low marginal costs for making additional copies. Accordingly, it is preferable to confirm and verify the proper operation of a circuit prior to fabricating it. Design and testing tools can be used to both design and verify the proper operation of a design for an electronic circuit. One function of a design tool, known as a place and route (PNR), can be used to place standard cell library based gates appropriately on the chip such that it meets the internal timing requirements such as setup or hold timing on the latches/flip-flops. The Pnr engine finally connects all the gates by its router through metal interconnects.

Referring now to FIG. 2, there is illustrated a flow diagram for verifying and simulating a circuit, such as circuit 100. At 205, the first module 105 and connections on the printed circuit board 115 (connections 420) between the first module 105 and the second module 110 are modeled as a new module 105′. The modeling of the first module 105 and the connections 420 on the printed circuit board 115 includes generating an electronic description of the design of the foregoing as a single piece.

At 210, the second module is modeled. At 215, the constraints for the interaction between the first module 105 and the second module 110 are modeled as set up port requirements. At 220, a model of the circuit 100 comprising the combined model and a model for the second module 110 are simulated and verified using the set up port requirements provided during 215.

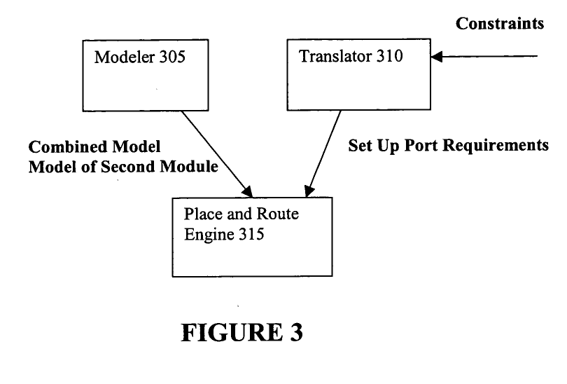

Referring now to FIG. 3, there is illustrated a block diagram describing an exemplary system for verifying and simulating a circuit, such as circuit 100. The system comprises a modeler 305, a constraint translator 310, and a place and route engine 315.

The modeler 305 generates a model of the first module 105 and the printed circuit board 115 as a single piece (now referred to as a combined model), as well as a model of the second module 110. The modeler 305 can generate the combined model in several ways. For example, the modeler 305 can generate the combined model by either receiving a module of the first module 105 and a model of the printed circuit board 115 and generating the combined model from the model of the first module 105 and the model of the printed circuit board 115. Alternatively, the modeler 305 can create the combined module by generating the models of the first module 105 and the printed circuit board 115 connections 420, and generating the combined model, therefrom. Additionally, the modeler 305 can generate the combined model, without models for module 105 and the printed circuit board 115.

The translator receives constraints for the circuit 100 and converts the constraints to set up port requirements. The place and route engine 315 simulates and verifies a model of circuit 100 comprising the combined model and the model of the second module 110.

In certain embodiments of the present invention, the circuit 100 can comprise a memory system, wherein the first module 105 comprises and SD-RAM and the second module comprises a DDR controller 110. The constraints can comprise delay and timing constraints.

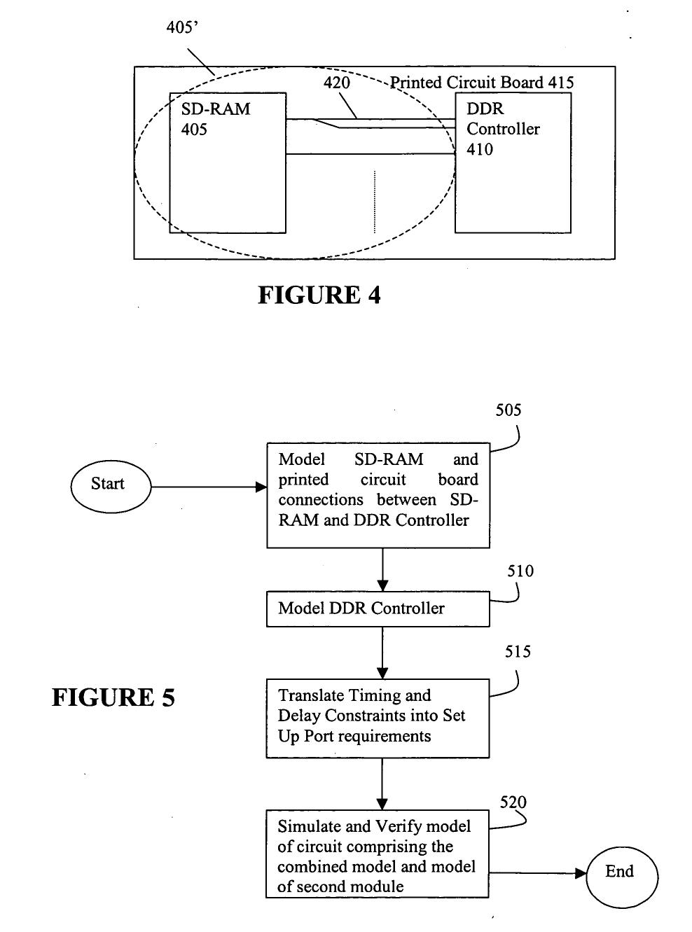

Referring now to FIG. 4, there is illustrated a block diagram describing an exemplary memory system 400 that can be simulated and verified in accordance with an embodiment of the present invention. The memory system comprises an SD-RAM 405, a DDR controller 410, and a printed circuit board 415. The printed circuit board 415 comprises connections 420, wherein the SD-RAM 405 and the DDR controller 410 can interact.

Referring now to FIG. 5, there is illustrated a flow diagram for verifying and simulating a memory circuit, such as memory circuit 400. At 505, the SD-RAM 405 and the connections 420 on the printed circuit board 415 between the SD-RAM 405 and the DDR controller 410 are modeled as a new module 105′. The modeling of the SD-RAM 405 and the connections 420 on the printed circuit board 415 includes generating an electronic description of the design of the foregoing as a single piece.

At 510, the DDR controller 410 is modeled. At 515, the timing and delay constraints for the interaction between the SD-RAM 405 and the DDR controller 410 are modeled as set up port requirements. At 520, a model of the memory system 400 that comprises the combined model and the model for the DDR controller 410 are simulated and verified using the set up port requirements provided during 515.

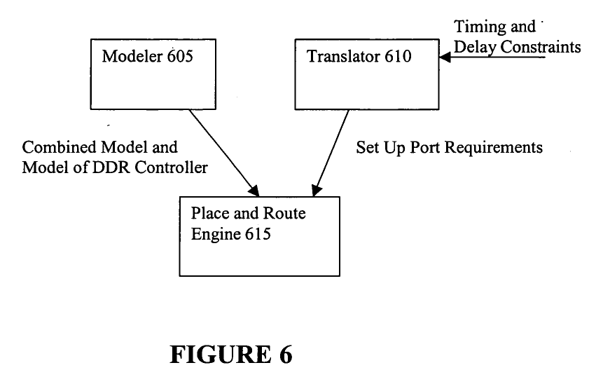

Referring now to FIG. 6, there is illustrated a block diagram describing an exemplary system for verifying and simulating a memory circuit, such as memory circuit 400. The system comprises a modeler 605, a constraint translator 610, and a place and route engine 615.

The modeler 605 generates a model of the SD-RAM 405 and the printed circuit board 415 as a single piece (now referred to as a combined model), as well as a model of the DDR controller 410. The modeler 605 can generate the combined model in several ways. For example, the modeler 305 can generate the combined model by either receiving a module of the SD-RAM 405 and a model of the printed circuit board 415 and generating the combined model from the model of the SD-RAM 405 and the model of the printed circuit board 415. Alternatively, the modeler 605 can create the combined module by generating the models of the SD-RAM 405 and the printed circuit board 415 connections 420, and generating the combined model, therefrom. Additionally, the modeler 605 can generate the combined model, without models for the SD-RAM 405 and the printed circuit board 415.

The translator 610 receives the timing and delay constraints for the memory system 400 and converts the constraints to set up port requirements. The place and route engine 615 simulates and verifies a model of the memory system 400 comprising the combined model and the model of the DDR controller 410. Path constraints can be broken into individual sub-paths and the timings can be budgeted on the sub-paths. This enables the place and route engine to understand the interface equations by many short timing constraints. The type of constraints are minimum delay, maximum delay, and setup port requirement and hold timing requirements on ports.

In certain embodiments of the present invention, the timing and delay constraints can be associated with delay requirements between signals, such as a data query signal (DQS) and a data clock signal. The delay matching requirement for the address and data signals can be translated into net requirements to be given to the place and route engine 615. Path constraints can be broken into individual sub-paths and the timings can be budgeted on the sub-paths.

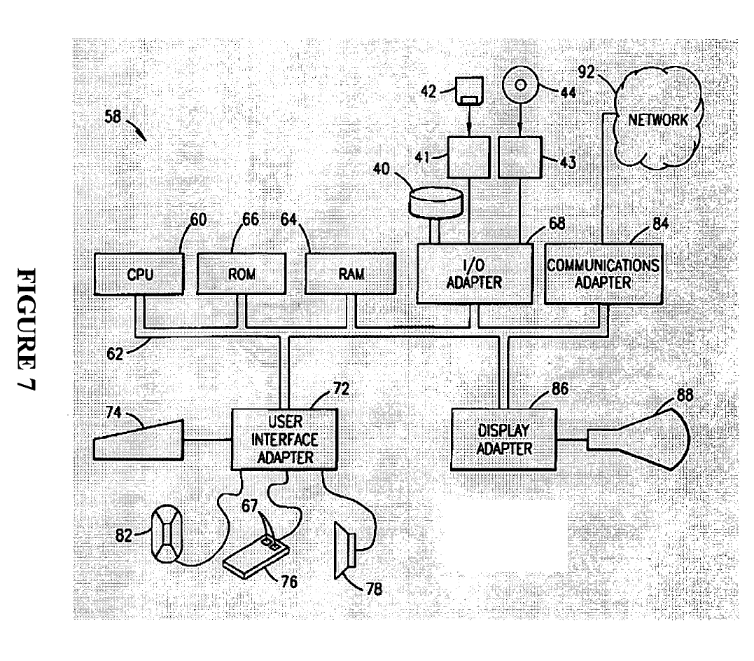

Referring now to FIG. 7, there is illustrated a block diagram of an exemplary information handling system configured in accordance with an embodiment of the present invention. A CPU 60 is interconnected via system bus 62 to random access memory (RAM) 64, read only memory (ROM) 66, an input/output (I/O) adapter 68, a user interface adapter 72, a communications adapter 84, and a display adapter 86. The input/output (I/O) adapter 68 connects peripheral devices such as hard disc drives 40, floppy disc drives 41 for reading removable floppy discs 42, and optical disc drives 43 for reading removable optical disc 44 (such as a compact disc or a digital versatile disc) to the bus 62. The user interface adapter 72 connects devices such as a keyboard 74, a mouse 76 having a plurality of buttons 67, a speaker 78, a microphone 82, and/or other user interfaces devices such as a touch screen device (not shown) to the bus 62. The communications adapter 84 connects the computer system to a data processing network 92. The display adapter 86 connects a monitor 88 to the bus 62.

An embodiment of the present invention can be implemented as sets of instructions resident in the random access memory 64 of one or more computer systems configured generally as described in FIG. 7. For example, the flow chart of FIGS. 2 and 5 can be implemented as sets of instructions in a computer system. Additionally, the systems described in FIGS. 3 and 6 can also be implemented as sets of instructions in a computer system. Until required by the computer system 58, the set of instructions may be stored in another computer readable memory, for example in a hard disc drive 40, or in removable memory such as an optical disc 44 for eventual use in an optical disc drive 43, or a floppy disc 42 for eventual use in a floppy disc drive 41. The physical storage of the sets of instructions physically changes the medium upon which it is stored electrically, magnetically, or chemically so that the medium carries computer readable information.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain functions can be implemented in firmware. In one embodiment, the present invention can comprise an integrated circuit.

While the invention has been described with reference to certain embodiments, it will be understood by those skilled in the art that various changes may be made and equivalents may be substituted without departing from the scope of the invention.

In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for simulating a circuit, said system comprising:
a modeler for modeling a first module and printed circuit connections connecting the first module to a second module, as a combined model, and for modeling the second module; and
a place and route engine for simulating a model comprising the combined model and the model of the second module.

2. The system of claim 1, further comprising:
a translator for translating constraints for the circuit into set up port requirements.

3. The system of claim 1, wherein the first module comprises an SD-RAM, and wherein the second module comprises a DDR controller.

4. The system of claim 3, further wherein the translator translates delay requirements for a signal to set up port requirements.

5. A method for simulating a circuit, said method comprising:
modeling a first module and printed circuit connections connecting the first module to a second module, as a combined model;
modeling the second module; and
simulating a model comprising the combined model and the model of the second module.

6. The method of claim 5, further comprising:
translating constraints for the circuit into set up port requirements.

7. The method of claim 5, wherein the first module comprises an SD-RAM, and wherein the second module comprises a DDR controller.

8. The method of claim 7, further comprising:
translating delay requirements for a signal to set up port requirements.

9. The method of claim 5, further comprising:
translating external constraints to internal constraints.

10. A machine readable media for simulating a circuit, said machine readable media storing a plurality of instructions, said plurality of instructions comprising:
modeling a first module and printed circuit connections connecting the first module to a second module, as a combined model;
modeling the second module; and
simulating a model comprising the combined model and the model of the second module.

11. The machine readable media of claim 10, wherein the plurality of instructions further comprises:
translating constraints for the circuit into set up port requirements.

12. The machine readable media of claim 10, wherein the first module comprises an SD-RAM, and wherein the second module comprises a DDR controller.

13. The machine readable media of claim 12, further comprising:
translating delay requirements for a signal to set up port requirements.

14. A system for simulating a circuit, said system comprising:
a processor; and
machine readable media connected to the processor, said machine readable media storing a plurality of instructions that are executable by the processor, wherein execution of the plurality of instructions by the processor causes:
modeling a first module and printed circuit connections connecting the first module to a second module, as a combined model;
modeling the second module; and
simulating a model comprising the combined model and the model of the second module.

15. The system of claim 14, wherein execution of the plurality of instructions by the processor also causes:
translating constraints for the circuit into set up port requirements.

16. The system of claim 14, wherein the first module comprises an SD-RAM, and wherein the second module comprises a DDR controller.

17. The system of claim 16, wherein execution of the plurality of instructions by the processor also causes:
translating delay requirements for a signal to set up port requirements.
